(19) United States
(12) Patent Application Publication
(10) Pub. No.: US 2022/0295746 A1
(43) Pub. Date: Sep. 22, 2022

(54) PET TOY

(71) Applicant: Doskocil Manufacturing Company, Inc., Arlington, TX (US)

(72) Inventors: Josiah WILHELM, Fort Worth, TX (US); Ronald BAGLEY, Dallas, TX (US); Sunil PINTO, Arlington, TX (US)

(21) Appl. No.: 17/507,878

(22) Filed: Oct. 22, 2021

Related U.S. Application Data
(60) Provisional application No. 63/164,222, filed on Mar. 22, 2021.

(51) Int. Cl. A01K 15/02; G10K 3/00

(52) U.S. Cl. CPC A01K 15/025; G10K 3/00

(57) ABSTRACT

A pet toy includes a main body and a noise producing device. The main body has an outer surface and an interior chamber with at least one opening extending from the interior chamber to the outer surface. The noise producing device is located within the interior chamber. The noise producing device has a hollow interior with a movable member disposed therein. The movable member is free to randomly move in three dimensions within the hollow interior.

### CROSS-REFERENCE TO RELATED APPLICATIONS

This application claims priority to U.S. Provisional Patent Application No. 63/164,222, filed on Mar. 22, 2021. The entire disclosure of which is incorporated herein by reference.

### BACKGROUND

### Field of the Invention

The present invention relates to a sound making pet toy. The pet toy has an outer main body is made of an elastic or rubber-like material, with a sound making device embedded therein. The main body includes a plurality of openings that allow some sound to be emitted from the noise making device, whereas the remainder of the main body limits the amount of sound from the noise making device.

### Background of the Invention

Some conventional pet toys have sound making capabilities incorporated therein that are often very loud. When a pet plays with a sound making pet toy for an extended period of time, the constant prolonged sounds can be a strain on the pet owner.

### SUMMARY

It has been discovered that a pet toy with an improved noise producing device is desired. In view of the state of the known technology, a first aspect of the present disclosure is to provide a pet toy that includes a main body and a noise producing device. The main body has an outer surface and an interior chamber with at least one opening extending from the interior chamber to the outer surface. The noise producing device is located within the interior chamber. The noise producing device has a hollow interior with a movable member disposed therein. The movable member is free to randomly move in three dimensions within the hollow interior.

In a second aspect of the present disclosure in accordance with the first aspect, the main body has a circular outer periphery.

In a third aspect of the present disclosure in accordance with the first and second aspects, the outer surface has a first half that has a conical shape and a second half that defines another conical shape that is symmetrical to the conical shape of the first half.

In a fourth aspect of the present disclosure in accordance with the first through third aspects, the main body has a circular outer periphery with the first half of the outer surface extending in a first direction from the circular outer periphery and the second half of the outer surface extending in a second direction from the circular outer periphery opposite the first direction.

In a fifth aspect of the present disclosure in accordance with the first through fourth aspects, the at least one opening includes a plurality of first openings extending from the first half of the outer surface to the interior chamber and a plurality of second openings extending from the second half of the outer surface to the interior chamber.

In a sixth aspect of the present disclosure in accordance with the first through fifth aspects, the noise making device includes housing that defines the hollow interior with the movable member being confined within the hollow interior.

In a seventh aspect of the present disclosure in accordance with the first through sixth aspects, at least a portion of the movable member defines a conical shape.

In an eighth aspect of the present disclosure in accordance with the first through sixth aspects, the movable member has a ball shape.

In a ninth aspect of the present disclosure in accordance with the first through eighth aspects, the housing of the has an interior surface that includes a plurality of radially inwardly extending projections such that in response to movement of the movable member, contact between the radially inwardly extending projections and the movable member produce a noise.

In a tenth aspect of the present disclosure in accordance with the first through ninth aspects, the interior surface of the housing further includes a projecting member that has a plurality of radially outwardly extending projections such that in response to movement of the movable member, contact between the radially outwardly extending projections and the movable member produce another noise.

In an eleventh aspect of the present disclosure in accordance with the first through tenth aspects, the interior surface of the housing further includes a projecting member that has a plurality of radially outwardly extending projections such that in response to movement of the movable member, contact between the radially outwardly extending projections and the movable member produce a noise.

In a twelfth aspect of the present disclosure in accordance with the first through eleventh aspects, the noise making device includes housing that defines the hollow interior with the movable member confined within the hollow interior.

In a thirteenth aspect of the present disclosure in accordance with the first through twelfth aspects, at least a portion of the movable member defines a conical shape.

In a fourteenth aspect of the present disclosure in accordance with the first through thirteenth aspects, the movable member has a ball shape.

In a fifteenth aspect of the present disclosure in accordance with the first through fourteenth aspects, the housing of the has an interior surface that includes a plurality of radially inwardly extending projections such that in response to movement of the movable member, contact between the radially inwardly extending projections and the movable member produce a noise.

In a sixteenth aspect of the present disclosure in accordance with the first through fifteenth aspects, the interior surface of the housing further includes a projecting member that has a plurality of radially outwardly extending projections such that in response to movement of the movable member, contact between the radially outwardly extending projections and the movable member produce another noise.

In a seventeenth aspect of the present disclosure in accordance with the first through sixteenth aspects, the interior surface of the housing further includes a projecting member that has a plurality of radially outwardly extending projections such that in response to movement of the movable member, contact between the radially outwardly extending projections and the movable member produce a noise.

### BRIEF DESCRIPTION OF THE DRAWINGS

Referring now to the attached drawing which form a part of this original disclosure:

FIG. 1 is a side view of a pet toy having a main body with a first half and a second half in accordance with a first embodiment;

FIG. 2 is a top view of the pet toy showing openings and geometrically shaped depressions formed along the first half (an upper half) of the main body in accordance with the first embodiment;

FIG. 3 is a perspective view of a bottom half of the pet toy showing openings and geometrically shaped depressions formed along the second half (a lower half) of the main body in accordance with the first embodiment;

FIG. 4 is a cross-sectional view of the pet toy taken along the line 4-4 in FIG. 2 showing an interior chamber of the main body of the pet toy with a noise producing device embedded within the interior chamber in accordance with the first embodiment;

FIG. 5 is a perspective view of the first half (the upper half) of the main body of the pet toy showing the openings and the geometrically shaped depressions with portions of the noise producing device being exposed within the openings in accordance with the first embodiment;

FIG. 6 is a perspective view of the second half (the lower half) of the main body of the pet toy showing the openings and the geometrically shaped depressions with portions of the noise producing device being exposed within the openings in accordance with the first embodiment;

FIG. 7 is a first side view of the main body of the pet toy showing the openings and the geometrically shaped depressions of the first and second halves of the main body in accordance with the first embodiment;

FIG. 8 is a second side view of the main body of the pet toy with the main body rotated 180 degrees about a central axis thereof relative to the depiction of the pet toy in FIG. 7, showing the openings and the geometrically shaped depressions of the first and second halves of the main body in accordance with the first embodiment;

FIG. 9 is a perspective view of the noise producing device removed from the interior chamber of the main body of the pet toy showing a first portion and a second portion of a housing of the noise producing device in accordance with the first embodiment;

FIG. 10 is a perspective view of the first portion of the housing of the noise producing device with the second portion removed therefrom showing an inner surface of a hollow interior of the housing with first gear teeth (outwardly extending projections), second gear teeth (inwardly extending projections) and a movable member disposed within the hollow interior in accordance with the first embodiment;

FIG. 11 is an end view of the first portion of the housing of the noise producing device showing the inner surface of the hollow interior thereof, the first gear teeth (outwardly extending projections), the second gear teeth (inwardly extending projections) and the movable member disposed within the hollow interior in accordance with the first embodiment;

FIG. 12 is a cross-sectional side view of the housing of the noise producing device showing the inner surface of the hollow interior thereof, the first gear teeth (outwardly extending projections), the second gear teeth (inwardly extending projections) and the movable member disposed within the hollow interior in accordance with the first embodiment;

FIG. 13 is a perspective view of the first portion of the housing of the noise producing device showing the inner surface of the hollow interior of the housing with first gear teeth (outwardly extending projections), second gear teeth (inwardly extending projections) and a movable member disposed within the hollow interior in accordance with a second embodiment;

FIG. 14 is a side view of the movable member depicted in FIG. 13 removed from the noise producing device, the movable member having a conical shape in accordance with the second embodiment; and

FIG. 15 is a side view of a movable member removed from the noise producing device, the movable member having a first conical portion and a second conical portion fixed to another in accordance with a third embodiment.

### DETAILED DESCRIPTION OF THE EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

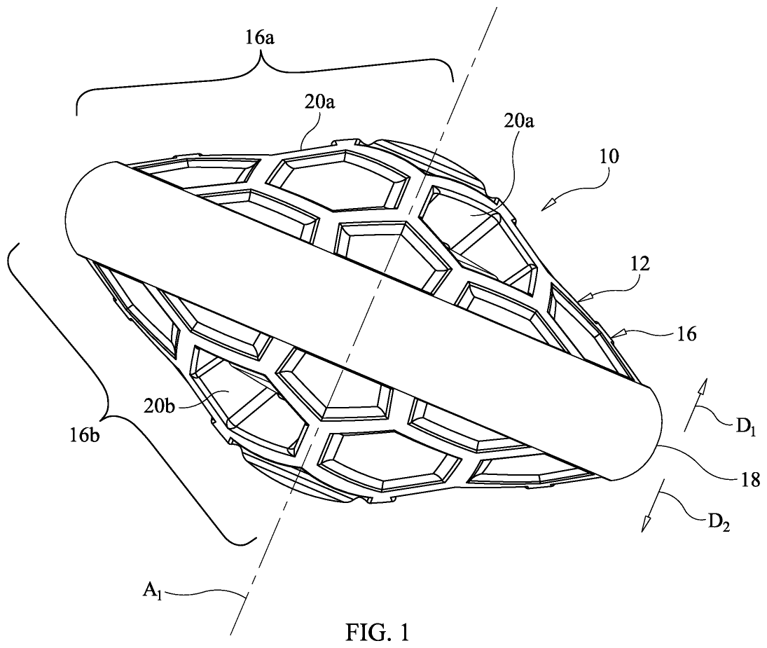

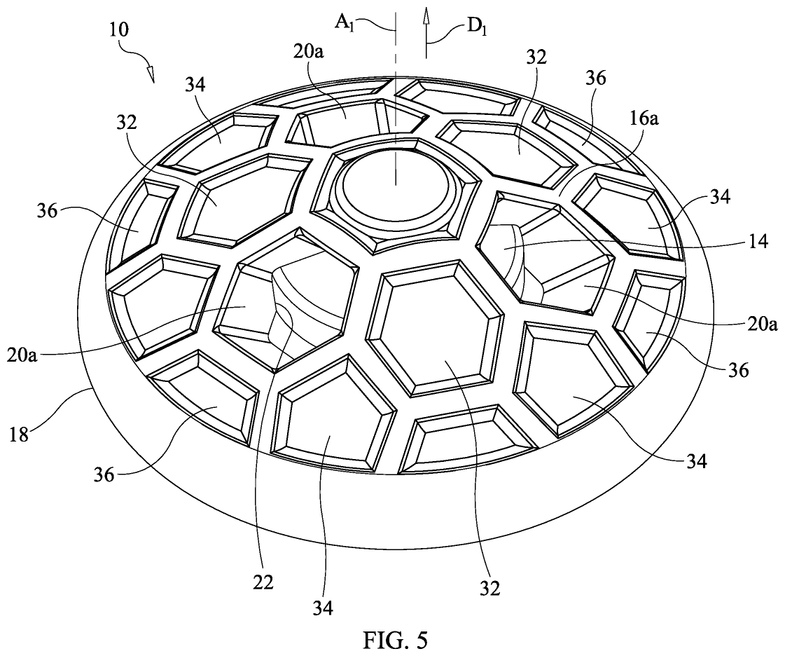

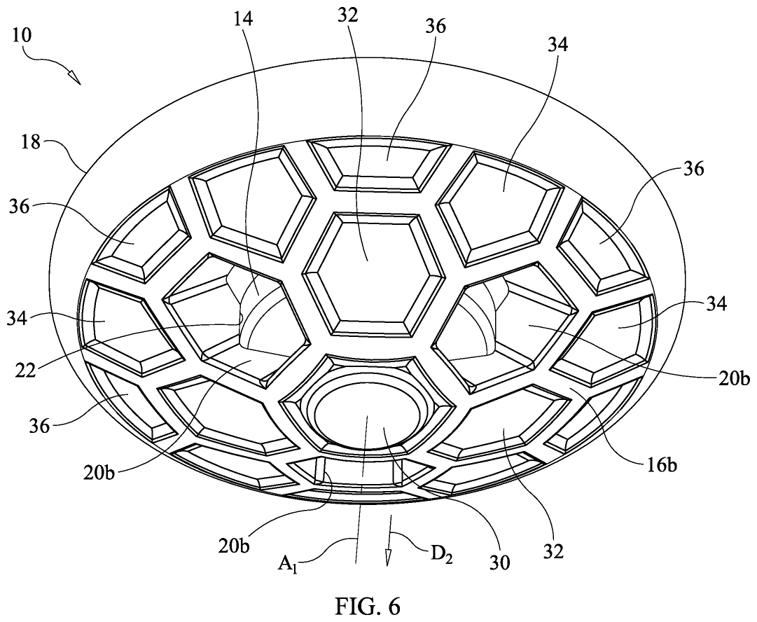

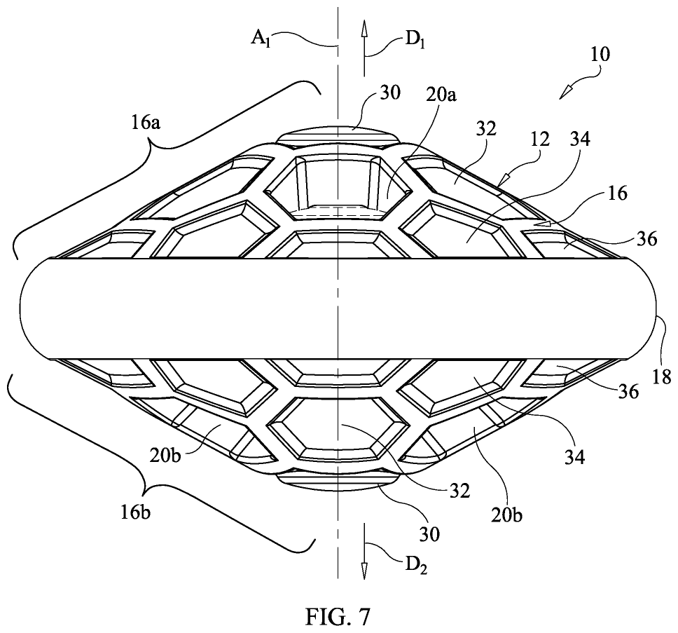

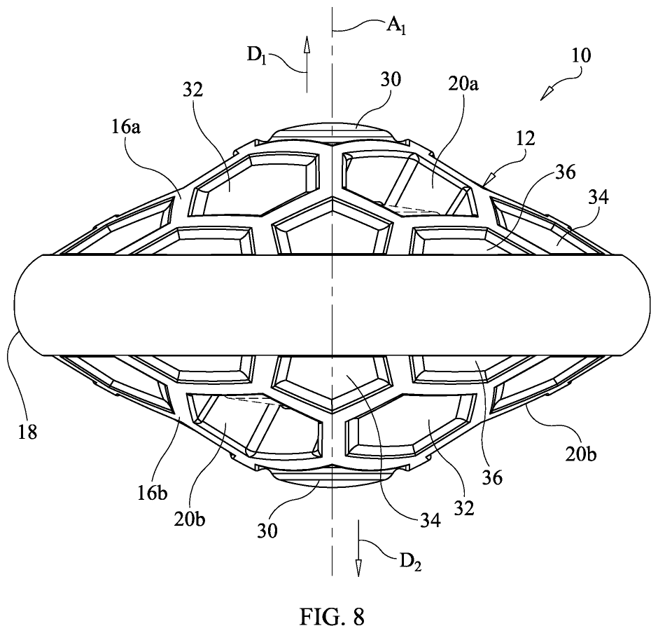

Referring initially to FIGS. 1-8, a pet toy 10 is illustrated in accordance with a first embodiment.

The pet toy 10 has a main body 12 and a noise producing device 14 located within the main body 12. The pet toy 10 defines a central axis A₁. The main body 12 has an outer surface 16 that resembles a spinning top. More specifically, the outer surface 16 has a first half portion 16a and a second half portion 16b. The first half portion 16a defines a conical shape with a centerline that coincides with the central axis A₁. The second half portion 16b also defines a conical shape with a centerline that coincides with the central axis A₁. Larger ends or bases of each of the first half portion 16a and the second half portion 16b are joined to define a central outer periphery 18 that has a circular or annular shape. The central outer periphery 18 is further provided with a curved or semicircular contoured when viewed from the side, as shown in FIGS. 1 and 3-8. The first half portion 16a and the second half portion 16b are symmetrical to one another relative to the circular shaped outer periphery 18.

As shown in FIGS. 1, 3-4 and 7-8, the first half portion 16a of the outer surface 16 extends in a first direction D₁ from the circular outer periphery 18 and the second half portion 16b of the outer surface 16 extends in a second direction D₂ from the circular outer periphery 18. The first direction D₁ is opposite the second direction D₂. Depending upon a viewer's point of view, the first direction D₁ and the second direction D₂ are aligned with or parallel to the central axis A₁.

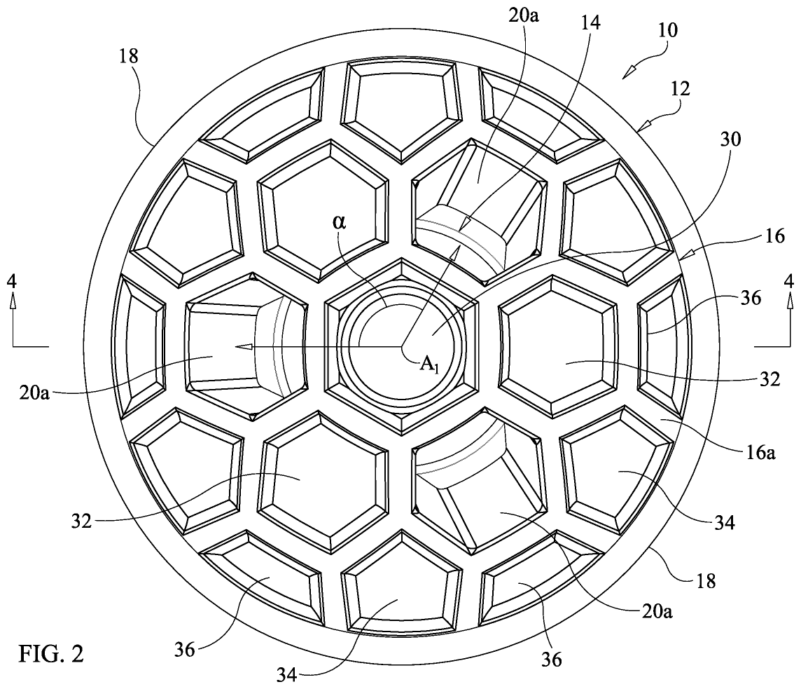

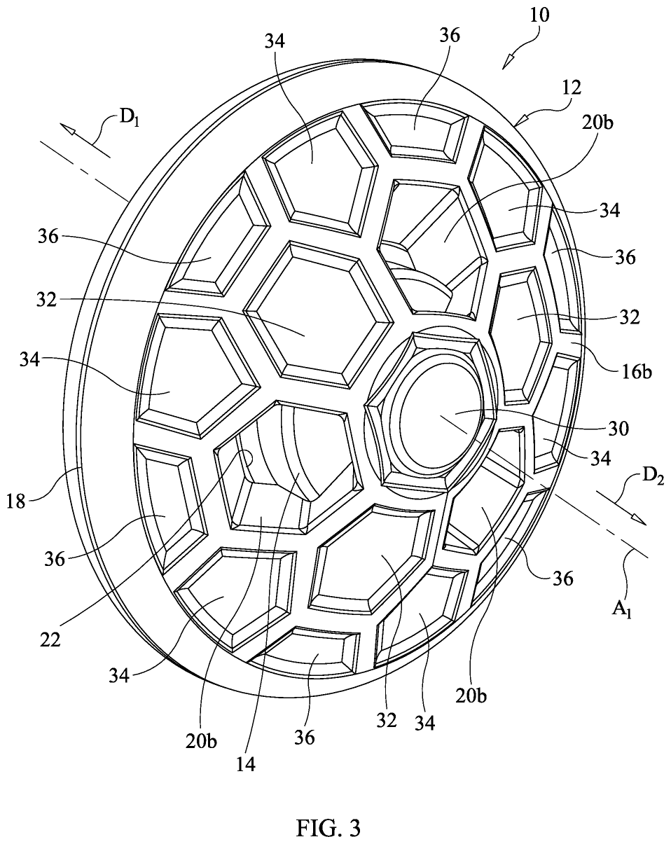

The main body 12 has a plurality of openings 20a and 20b are open to an interior chamber 22, shown in FIGS. 1-8. In the illustrated embodiment, there are six openings 20a and 20b altogether. A plurality of three first openings 20a extend from the first half portion 16a of the surface 16 to the interior chamber 22, as shown in FIGS. 2, 4-5 and 7-8. A plurality of second openings 20b extend from the second half portion 16b of the surface 16 to the interior chamber 22, as shown in FIGS. 3 and 6-8.

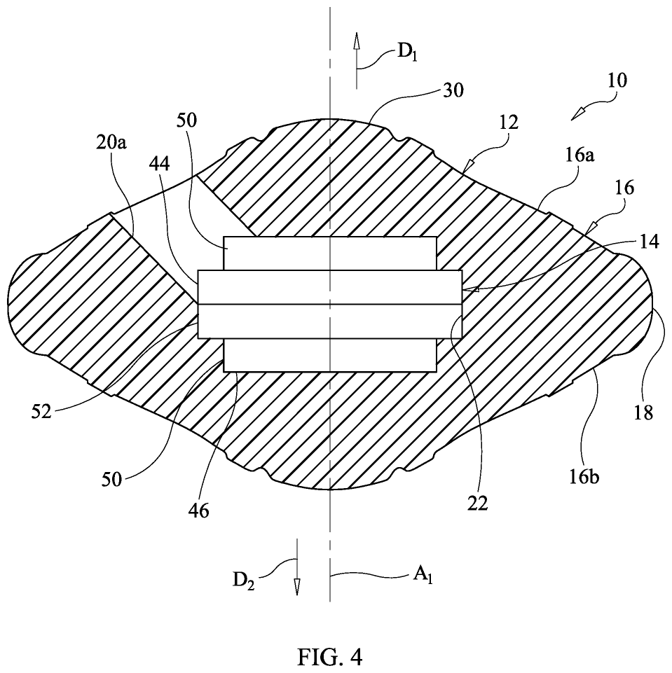

Although the first half portion 16a and the second half portion 16b of the outer surface 16 of the main body 12 are symmetrically shaped, the plurality of first openings 20a are offset from the plurality of second openings 20b relative to the circular outer periphery, as is shown in FIGS. 1 and 7-8. More specifically, the first openings 20a are angularly offset from one another by 120 degrees, relative to the central axis A₁. Similarly, the second openings 20b are angularly offset from one another by 120 degrees, relative to the central axis A₁. However, the first openings 20a are angularly offset from the second openings 20b by 60 degrees, relative to the central axis A₁, as shown in FIGS. 1, 7 and 8. Therefore, in FIG. 4, only one of the first openings 20a is shown in cross-section.

As shown in FIGS. 1-3 and 5-8, the outer surface 16, including both the first half portion 16a and the second half portion 16b, of the main body, includes a plurality of geometrically shaped depressions 30, 32, 34 and 36 (hereinafter the depressions 30, 32, 42 and 36). The geometrically shaped depressions 30 that are centered in alignment with the central axis A₁, are six sided, each resembling a hexagon. Similarly, the upper most and lower most geometrically shaped depressions 32 (adjacent to the depressions 30) are also six sided resembling a hexagon. The openings 20a and 20b are similarly six sided and are located between adjacent ones of the depressions 32. The depressions 34 are five sided and the depressions 36 are four sided. The geometric shapes of the depressions 30-36 can be modified in any of a variety of ways such that they can be hexagonally shaped, pentagon shaped, square shaped, rhomboid shaped, or other shapes. These geometrically shaped depressions provide a grip area for a pet's teeth to bite onto and hold the pet toy 10.

In the depicted embodiment, the outer surface 16 of the main body 12 of the pet toy 10 is smooth, except for the inclusion of the openings 20a and 20b and the depressions 30-36. Alternatively, the outer surface 16 can also be provided with contours such as: a continuous or partially continuous series of small bumps; a generally rough surface texture; or a series of ridges.

The main body 12 is formed by, for example, injection molding about the noise producing device 14. Further, the main body 12 can be molded such that the noise producing device 14 is embedded within the interior chamber 22 of the main body 12. As shown in FIG. 4, portions of the noise producing device 14 are exposed via the plurality of openings 20a and 20b. Hence, the openings 20a and 20b allowing noise produced by the noise producing device 14 to be heard by a pet playing with the pet toy 10. However, since a majority of the outer surface of the noise producing device 14 is covered by the main body 12, the sounds produced by the noise producing device 14 are partially muted.

The main body 12 can be made of any of a variety of flexible and resilient materials, such as rubber, rubber-like materials, polymers, and resinous materials, so long as the material has sufficient durability to withstand repeated dog bites (with sharp teeth).

The main body 12 can also be made of any of a plurality of moldable materials. For example, the main body can be made using a plastic extrusion technique using acrylonitrile butadiene styrene (ABS), which is a common thermoplastic polymer typically used for injection molding, applications. This engineering plastic is popular due to its low production cost and the ease with which the material is machined by plastic, manufacturers. Better yet, its natural benefits of affordability and machinability do not hinder the ABS material's desired properties, which include a predetermined, but low level of flexibility, a high degree of resilience and a low density, making the main body 12 easy for a pet to grab, carry around and play with.

The interior chamber 22 is defined at a central location within the main body 12 and is centered with respect to the central axis A₁. The noise producing device 14 is embedded within (located) within the interior chamber 22. Preferably, the main body 12 is formed about the noise producing device 14.

The noise producing device 14 is shown in FIG. 4 with the main body 12 shown in cross-section revealing the chamber 22. The noise producing device 14 is embedded within the chamber 22. The noise producing device 14 is also visible through the plurality of openings 20a and 20b, as shown in FIGS. 2-3 and 5-6.

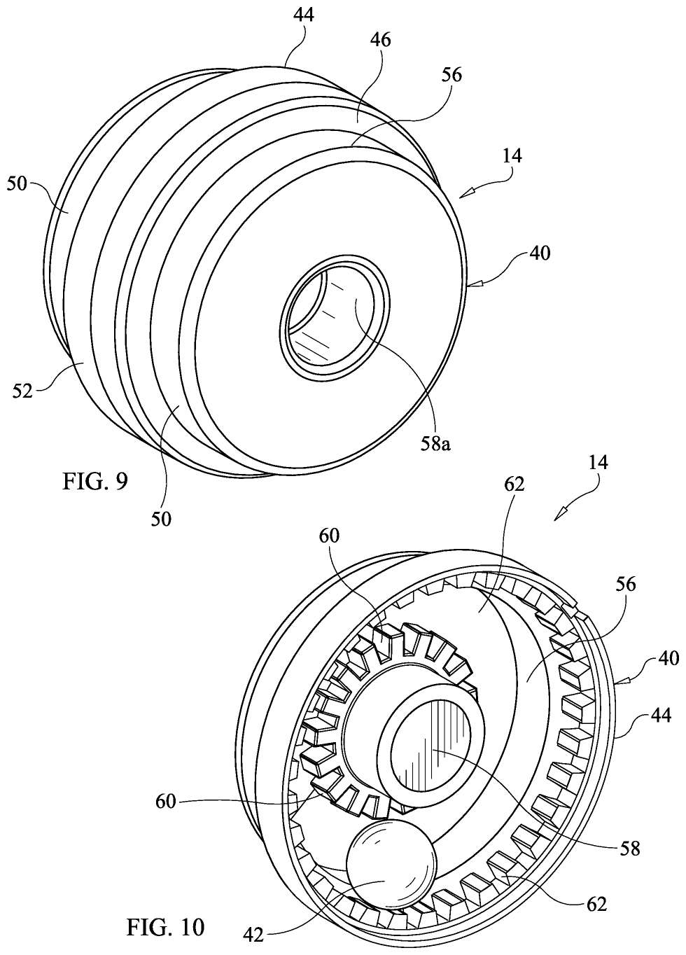

The noise making device 14 is shown removed from the main body 12 in FIGS. 9-12. The noise producing device 14 includes a housing 40 and a movable member 42. The housing 40 has a first half 44 and a second half 46 that are identical to one another. The first half 44 and the second half 46 of the housing 40 are fixedly attached to one another defining a hollow interior 48 therebetween. Since the first and second halves 44 and 46 are basically identical, description of only the first half 44 is provided for the sake of brevity but applies equally to the second half 46.

As shown in FIGS. 9-12, the housing 40 has an overall cylindrical shape or shapes. Specifically, end portions of the housing 40 have a reduced diameter portion 50, as compared to a central portion 52 of the housing 40. The outer diameter of the central portion 52 is larger than the reduced diameter portions 50 (end portions) of the housing 40.

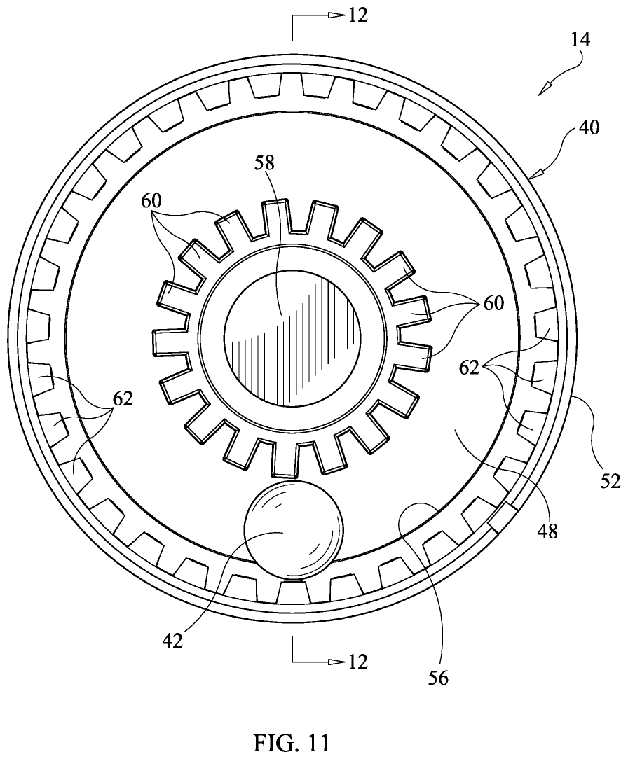

The first half 44 of the housing 40, as shown in FIGS. 10 and 11, includes an inner surface 56 that includes a projecting portion 58, radially outwardly extending first gear teeth 60 and radially inwardly extending second gear teeth 62. The first gear teeth 60 are formed on a portion of the projecting portion 58 within the reduced diameter portion 50 of the first half 44 of the housing 40. The second gear teeth 62 are formed on a portion of the inner surface 56 along a portion of central portion 52 of the first half 44 of the housing 40.

The projecting portion 58 can define a depression 58a or concaved space along the outer surface of the housing 40, as shown in FIG. 9.

The first and second halves 44 and 46 of the housing 40 can be made of a metallic material, alloy, plastic or polymer material, so long as the material of the housing 40 can produce a desired level of noise when contacted by the movable member 42 making contact therewith within the hollow interior 48.

It should be understood from the drawings and the description herein that the overall dimensions of each of the first gear teeth 60 and the second gear teeth 62 can be augmented, changed and re-shaped, as necessary in order to engage with the movable member 42 for producing a desired level of noise.

As shown in FIGS. 10-12, the movable member 42 is confined within the hollow interior 44 of the housing 40. As a pet plays with the pet toy 10 and moves it about, the movable member 42 rolls, bounces and moves about within the hollow interior 48 of the housing 40.

The movable member 42 is provided with a spherical shape, as shown in FIGS. 10-12. The movable member 42 contacts, roles along and/or bounces between portions of the inner surface 56 of the housing 40, the first gear teeth 60 (outwardly extending projections), the second gear teeth 62 (inwardly extending projections) and the projections 58 within the housing 40 making corresponding noises. The movable member 42 can be a metal ball bearing or other similar spherical ball made of metal or can be made of a dense polymer material that can provide a desired level of noise when contacting the portions of the inner surface 56 of the housing 40, the first gear teeth 60, the second gear teeth 62 and the projections 58.

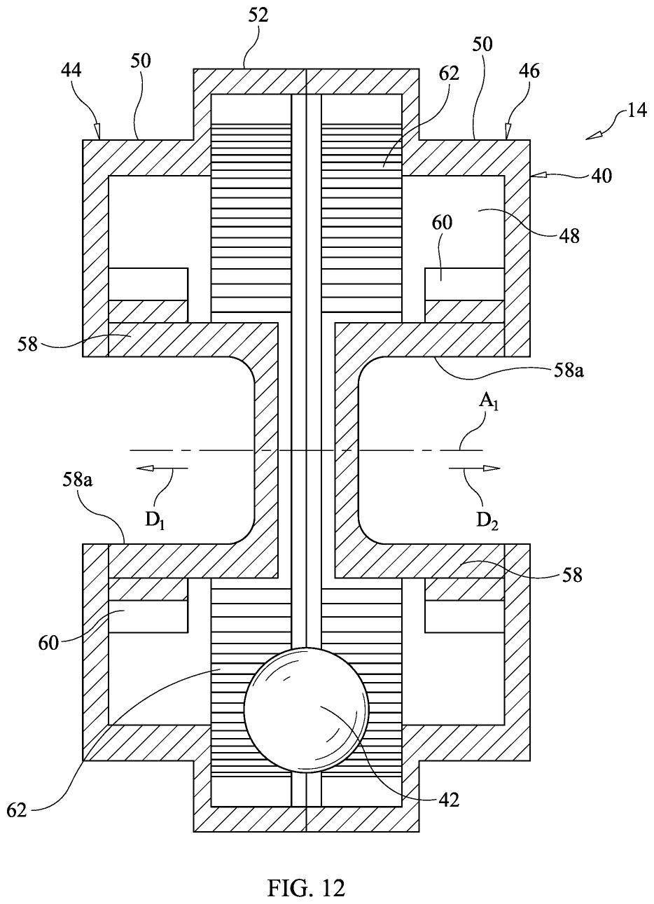

As shown in FIGS. 10-12, the size of the movable member 42 is such that the movable member 42 is free to randomly move in three dimensions within the hollow interior 48. For instance, as is shown in FIG. 12 with the movable member 42 at rest, the movable member 42 is spaced apart from the first gear teeth 60 (first projections). Therefore, the movable member 42 is free to move back and forth horizontally in the space between the first gear teeth 60 (relative to the orientation of the noise producing device 14 in FIG. 12). In FIG. 12, the movable member 42 is resting on the second gear teeth 62 (second projections). The movable member 42 is spaced apart from the projecting portions 58. Therefore, the movable member 42 is free to move up and down in the space between the second gear teeth 62 and the projecting portions 58 (relative to the orientation of the noise producing device 14 in FIG. 12). Further, the hollow interior 48 has an annular shape, as shown in FIGS. 10 and 11. Therefore, the movable member 42 free to undergo limited movement in directions perpendicular to the image depicted in FIG. 12 within the confines of the annular shape of the hollow interior 48. Further, the movable member 42 can be made to move in circular directions about the central axis A₁ within the confines of the annular shape of the hollow interior 48. Hence, the movable member 42 is free to randomly move in a variety of directions within the hollow interior 48.

The movable member 42 can have any of a variety of shapes. In the illustrated embodiment, the movable member 42 defines a spherical shape. Alternatively, the movable member can have a variety of shapes, including having square, rectangular, rhomboid, egg or football-like shape. The shape of the moveable member 42 can be altered in order attenuate the noise produced by the movement contact between the moveable member 42 and the inner surface 56 of the housing 40, the first gear teeth 60, the second gear teeth 62 and the projections 58.

Further, the technology used to produce the noise producing device 42 of the pet toy 10 can also incorporate an ABS sound chamber that has a ball bearing (one example of a movable member 42) and plastic teeth (the first and second gear teeth 60 and 62) on the top, bottom and side surfaces of the interior chamber 48. The plastic teeth are one example of the radially inwardly and outwardly extending projections (the first and second gear teeth 60 and 62). The ball bearing (the movable member 42) rolls around the chamber 48 in a circular motion causing a purring noise. No matter the direction the chamber is tilted or turned, the ball bearing can make contact with the teeth causing the sound to occur.

The openings 20a and 20b of the main body 12 of the pet toy 10 are designed to let the sound of the noise producing device 14 out of the toy 10 without completely muffling the sound. The overall shape of the main body 10 is designed to allow the toy 10 to roll/wobble on the first half portion 16a (a top thereof) or the second half portion 16b (a bottom thereof).

### Second Embodiment

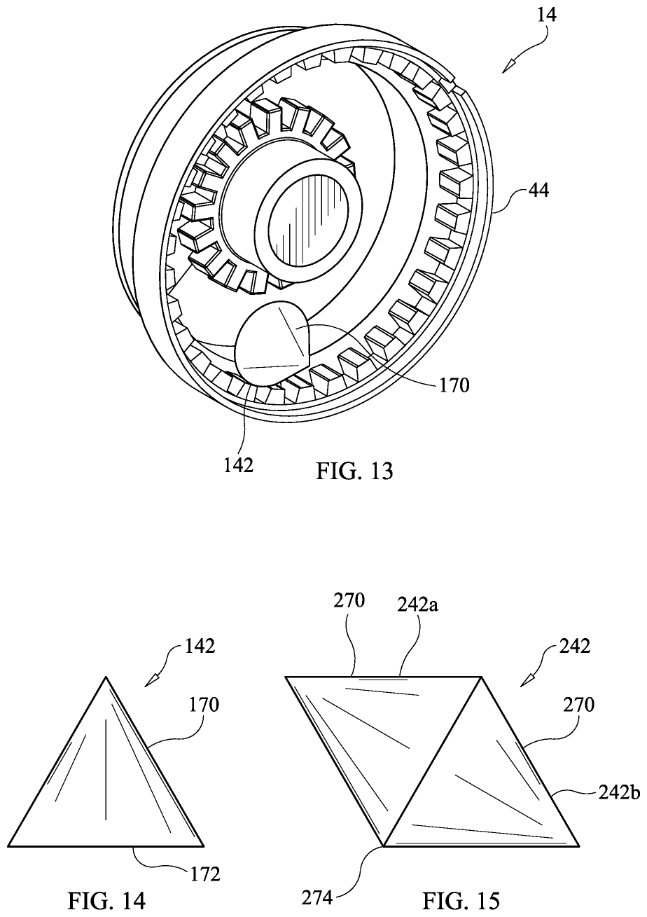

Referring now to FIGS. 13-14, a movable member 142 installed within the noise producing device 14 in accordance with a second embodiment will now be explained. In view of the similarity between the first and second embodiments, the parts of the second embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity.

The noise producing device 14 is identical to that described in the first embodiment and is installed within the interior chamber 22 of the main body 12 of the pet toy 10 as described in the first embodiment. The noise producing device 14 is unaltered as compared to the first embodiment. However, in the second embodiment, the movable member 42 of the first embodiment is replaced with the movable member 142.

The movable member 142 has a conical shape with a main surface 170 defining the cone shape and a flat bottom 172, as shown in FIG. 14.

### Third Embodiment

Referring now to FIG. 15, a moveable member 242 in accordance with a third embodiment will now be explained. In view of the similarity between the first and third embodiments, the parts of the third embodiment that are identical to the parts of the first embodiment will be given the same reference numerals as the parts of the first embodiment. Moreover, the descriptions of the parts of the third embodiment that are identical to the parts of the first embodiment may be omitted for the sake of brevity.

In the third embodiment, the movable member 42 of the first embodiment is replaced with the movable member 242.

The movable member 142 has a first conically shaped half 242a and a second conically shaped half 242b each having a main conical surface portion 270, as shown in FIG. 15. The first conically shaped half 242a is formed unitarily with the second conically shaped half 242b thereby defining a circular outer central edge 274, as shown in FIG. 15.

### General Interpretation of Terms

In understanding the scope of the present invention, the term “comprising” and its derivatives, as used herein, are intended to be open ended terms that specify the presence of the stated features, elements, components, groups, and/or steps, but do not exclude the presence of other unstated features, elements and components, groups. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Accordingly, these terms, as utilized to describe the present invention should be interpreted relative to the pet toy 10.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. The functions of one element can be performed by two, and vice versa. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed:

1. A pet toy comprising:
a main body having an outer surface and an interior chamber with at least one opening extending from the interior chamber to the outer surface;
a noise producing device located within the interior chamber, the noise producing device having a hollow interior with a movable member disposed therein, the movable member being free to randomly move in three dimensions within the hollow interior.

2. The pet toy according to claim 1, wherein
the main body has a circular outer periphery.

3. The pet toy according to claim 1, wherein
the outer surface has a first half that has a conical shape and a second half that defines another conical shape that is symmetrical to the conical shape of the first half.

4. The pet toy according to claim 3, wherein
the main body has a circular outer periphery with the first half of the outer surface extending in a first direction from the circular outer periphery and the second half of the outer surface extending in a second direction from the circular outer periphery opposite the first direction.

5. The pet toy according to claim 4, wherein
the at least one opening includes a plurality of first openings extending from the first half of the outer surface to the interior chamber and a plurality of second openings extending from the second half of the outer surface to the interior chamber.

6. The pet toy according to claim 5, wherein
the noise making device includes housing that defines the hollow interior with the movable member being confined within the hollow interior.

7. The pet toy according to claim 6, wherein
at least a portion of the movable member defines a conical shape.

8. The pet toy according to claim 6, wherein
the movable member has a ball shape.

9. The pet toy according to claim 6, wherein
the housing of the has an interior surface that includes a plurality of radially inwardly extending projections such that in response to movement of the movable member, contact between the radially inwardly extending projections and the movable member produce a noise.

10. The pet toy according to claim 9, wherein
the interior surface of the housing further includes a projecting member that has a plurality of radially outwardly extending projections such that in response to movement of the movable member, contact between the radially outwardly extending projections and the movable member produce another noise.

11. The pet toy according to claim 6, wherein
the interior surface of the housing further includes a projecting member that has a plurality of radially outwardly extending projections such that in response to movement of the movable member, contact between the radially outwardly extending projections and the movable member produce a noise.

12. The pet toy according to claim 1, wherein
the noise making device includes housing that defines the hollow interior with the movable member being confined within the hollow interior.

13. The pet toy according to claim 12, wherein
at least a portion of the movable member defines a conical shape.

14. The pet toy according to claim 12, wherein
the movable member has a ball shape.

15. The pet toy according to claim 12, wherein
the housing of the has an interior surface that includes a plurality of radially inwardly extending projections such that in response to movement of the movable member, contact between the radially inwardly extending projections and the movable member produce a noise.

16. The pet toy according to claim 15, wherein
the interior surface of the housing further includes a projecting member that has a plurality of radially outwardly extending projections such that in response to movement of the movable member, contact between the radially outwardly extending projections and the movable member produce another noise.

17. The pet toy according to claim 12, wherein
the interior surface of the housing further includes a projecting member that has a plurality of radially outwardly extending projections such that in response to movement of the movable member, contact between the radially outwardly extending projections and the movable member produce a noise.
